(19) United States
(12) Patent Application Publication
(10) Pub. No.: US 2025/0245935 A1
(43) Pub. Date: Jul. 31, 2025

(54) INFORMATION PROCESSING DEVICE, INFORMATION PROCESSING SYSTEM, AND INFORMATION PROCESSING METHOD FOR CONTROLLING IMAGE DISPLAY, AND COMPUTER-READABLE STORAGE MEDIUM

(71) Applicant: CANON KABUSHIKI KAISHA, Tokyo (JP)

(72) Inventor: MASAHIKO OKUZAWA, Kanagawa (JP)

(21) Appl. No.: 19/035,576

(22) Filed: Jan. 23, 2025

(30) Foreign Application Priority Data
Jan. 29, 2024 (JP) 2024-010768

(51) Int. Cl. G06T 19/00; G06F 3/01; G06T 5/50

(52) U.S. Cl. CPC G06T 19/006; G06F 3/013; G06T 5/50; G06T 2207/20221

(57) ABSTRACT

An information processing device to execute image obtaining processing to obtain a captured image, execute line-of-sight obtaining processing to obtain a line of sight of a user, and execute display control processing to display a combined image obtained by combining the captured image with a virtual object on a display, wherein in the display control processing, transparency of the virtual object overlapping an area of a person included in the captured image is determined based on the line of sight of the user.

### BACKGROUND OF THE DISCLOSURE

### Field of the Disclosure

The present disclosure relates to an information processing device that controls display of images.

### Description of the Related Art

A user wears a head-mounted display (HMD) to experience a virtual reality (VR) space and a mixed reality (MR) space.

In the VR or MR space, an area in the real space is hidden behind a virtual object in many cases. A technique for displaying a virtual object in a transparent state when another person approaches the user is known. Japanese Patent Application Laid-Open No. 2006-301924 discusses a technique for displaying a virtual object in a transparent state as related art.

In some cases, there is an issue that the virtual object is displayed in the transparent state against the user's intention, for example, when the user wishes to visually recognize the virtual object even in a case where another person approaches the user.

### SUMMARY OF THE DISCLOSURE

The present disclosure is directed to providing a more user-friendly information processing device capable of reflecting the intention of a user.

According to an aspect of the present disclosure, an information processing device includes a processor, and a memory storing a program which, when executed by the processor, causes the information processing device to execute image obtaining processing to obtain a captured image, execute line-of-sight obtaining processing to obtain a line of sight of a user, and execute display control processing to display a combined image obtained by combining the captured image with a virtual object on a display, wherein in the display control processing, transparency of the virtual object overlapping an area of a person included in the captured image is determined based on the line of sight of the user.

Further features of the present disclosure will become apparent from the following description of exemplary embodiments with reference to the attached drawings.

### BRIEF DESCRIPTION OF THE DRAWINGS

FIG. 1 is a block diagram illustrating an internal configuration of an information processing device according to a first exemplary embodiment.

FIG. 2 is a flowchart illustrating processing that is performed by a control unit according to the first exemplary embodiment.

FIG. 3A illustrates an example of an image that is visually recognized by a user according to the first exemplary embodiment, FIG. 3B illustrates an example of the image that is visually recognized by the user according to the first exemplary embodiment, in which a person is hidden behind a virtual object, and FIG. 3C illustrates an example of the image that is visually recognized by the user according to the first exemplary embodiment, in which the transparency of the virtual object is changed.

FIG. 4A illustrates an example of the image visually that is recognized by the user according to the first exemplary embodiment when the user gazes at a subject, FIG. 4B illustrates an example of the image that is visually recognized by the user according to the first exemplary embodiment when the virtual object is displayed in an opaque state, and FIG. 4C illustrates an example of the image that is visually recognized by the user according to the first exemplary embodiment when a transparent state of the virtual object is maintained.

FIG. 5A illustrates an example of an image that is visually recognized by the user according to the first exemplary embodiment in a state where a person is hidden behind the virtual object in the opaque state, FIG. 5B illustrates an example of the image that is visually recognized by the user according to the first exemplary embodiment when the virtual object is displayed in a transparent state, and FIG. 5C illustrates an example of the image that is visually recognized by the user according to the first exemplary embodiment when the virtual object is displayed in the transparent state.

FIG. 6A illustrates an example of an image that is visually recognized by the user according to the first exemplary embodiment when the virtual object is displayed in the transparent state, FIG. 6B illustrates an example of the image that is visually recognized by the user according to the first exemplary embodiment when a line of sight of the user has moved onto a person in a state where the virtual object is displayed in the transparent state, and FIG. 6C illustrates an example of the image that is visually recognized by the user according to the first exemplary embodiment when the line of sight has moved onto the virtual object in a state where the virtual object is displayed in the transparent state.

FIG. 7A illustrates an example of an image that is visually recognized by the user in a virtual reality (VR) according to a second exemplary embodiment, and FIG. 7B illustrates an example of the image that is visually recognized by the user according to the second exemplary embodiment when a person is detected in the vicinity of the user in the VR mode.

FIG. 8A illustrates an example of an image in a state where the person detected in the vicinity of the user in the VR mode is displayed through the virtual object and a background image according to the second exemplary embodiment, FIG. 8B illustrates an example of an image that is visually recognized by the user according to the second exemplary embodiment when the opaque state is set in the VR mode, and FIG. 8C illustrates an example of the image that is visually recognized by the user according to the second exemplary embodiment when the virtual object is displayed in the opaque state in the VR mode and the background image is maintained in the transparent state.

FIG. 9A illustrates an example of an image in a state a person visually recognized by the user is displayed through the background image according to the second exemplary embodiment, FIG. 9B illustrates an example of the image that is visually recognized by the user according to the second exemplary embodiment, in which a virtual object and a background image are set to be half transparent with respect to the person, and FIG. 9C illustrates an example of the image that is visually recognized by the user according to the second exemplary embodiment, in which the opaque area of the background image is increased.

FIG. 10 is a flowchart illustrating processing that is performed by the control unit according to the first exemplary embodiment.

FIG. 11 is a flowchart illustrating processing that is performed by the control unit according to the second exemplary embodiment.

### DESCRIPTION OF THE EMBODIMENTS

Hereinafter, exemplary embodiments will be described in detail with reference to the accompanying drawings. The following exemplary embodiments do not limit the present disclosure according to the claims. While a plurality of features are described in the exemplary embodiments, all of the plurality of features are not necessarily essential to the present disclosure, and the plurality of features may be arbitrarily combined. In the accompanying drawings, the same or similar components are denoted by the same reference numerals, and redundant description will be omitted.

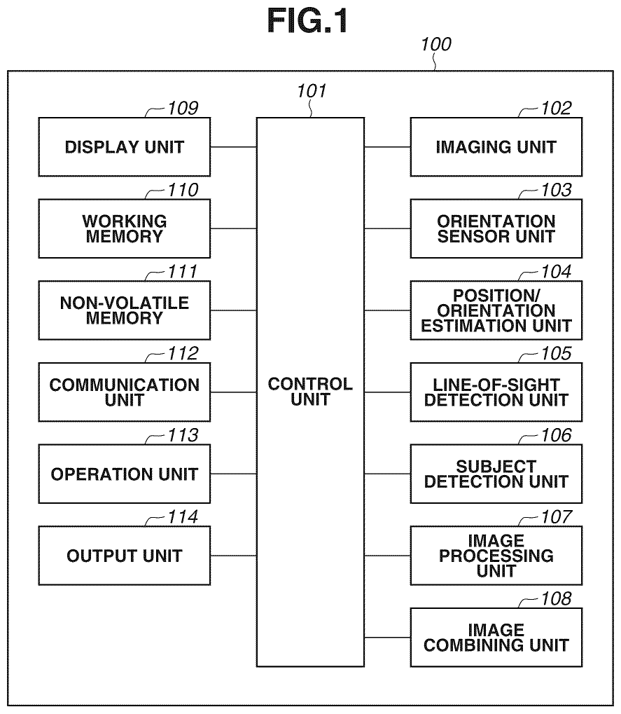

An internal configuration of an information processing device according to a first exemplary embodiment of the present disclosure will be described below with reference to FIG. 1. A head-mounted display (HMD) 100 is a head-mounted information processing device that is worn on the head of a user. The HMD 100 includes a control unit 101, an imaging unit 102, an orientation sensor unit 103, a position/orientation estimation unit 104, a line-of-sight detection unit 105, a subject detection unit 106, an image processing unit 107, an image combining unit 108, a display unit 109, a working memory 110, and a non-volatile memory 111.

The control unit 101 is a central processing unit (CPU) that controls each component of the HMD 100. Instead of controlling the entire operation of the information processing device by the control unit 101, a plurality of pieces of hardware may share processing to control the overall operation of the information processing device.

The imaging unit 102 is an image obtaining unit including two cameras (imaging devices). The two cameras capture images to be used to combine a captured with an image of a virtual space and to generate position and orientation information, and include a left-eye imaging unit and a right-eye imaging unit. The two cameras are disposed symmetrically with respect to the center of the HMD 100 to capture images in front of the user when the user is wearing the HMD 100. The left-eye imaging unit captures a moving image of the real space corresponding to the left eye of the user wearing the HMD 100, and the left-eye imaging unit outputs each frame image (captured image) in the moving image. The right-eye imaging unit captures a moving image of the real space corresponding to the right eye of the user wearing the HMD 100, and the right-eye imaging unit outputs each frame image (captured image) in the moving image. In other words, the imaging unit 102 obtains a captured image as a stereo image having a parallax approximately matching the positions of the left eye and the right eye of the user wearing the HMD 100. Information about a distance from the two cameras to a subject is obtained as distance information by ranging using the stereo camera. It is desirable that in the HMD 100 for a mixed reality (MR) system, a center optical axis of an imaging range of the imaging unit 102 be placed to approximately coincide with a line-of-sight direction of the user wearing the HMD 100.

The left-eye imaging unit and the right-eye imaging unit each include an optical system and an imaging device. Light entering from outside enters the imaging device through the optical system, and the imaging device outputs an image corresponding to the incident light as a captured image. Certain correction processing is performed on the images captured by the two cameras (not illustrated), and then the images are stored in the working memory 110. The imaging unit 102 may capture a video image instead of a captured image, and may output the captured video image.

While the first exemplary embodiment illustrates a configuration example where two cameras are used, one camera may be used, or three or more cameras may be used. The arrangement of the cameras is not limited to the above-described arrangement, and the cameras may be arranged at any locations.

The orientation sensor unit 103 is an inertial measurement unit (IMU) and incorporates a gyroscope sensor and an acceleration sensor. These sensors incorporated in the orientation sensor unit 103 are configured to obtain the angular velocity and the acceleration of the HMD 100 as sensor information. The orientation sensor unit 103 obtains orientation (and position) information about the HMD 100. The orientation sensor unit 103 may also obtain orientation information about the user (user wearing the HMD 100) corresponding to the orientation (and position) of the HMD 100.

The configuration of the orientation sensor unit 103 is not limited to the above-described configuration. The orientation information may be obtained from at least one of a magnetic sensor (including a magnetic field sensor), an ultrasonic sensor, an acceleration sensor, and an angular velocity sensor. The orientation sensor unit 103 may include any other sensors different from the above-described sensors.

The position/orientation estimation unit 104 estimates the position and orientation (hereinafter referred to as “position/orientation”) of the HMD 100 in the space based on the images captured by the imaging unit 102 and the sensor information obtained by the orientation sensor unit 103. In position/orientation estimation processing, the position/orientation estimation unit 104 receives the captured image obtained by the imaging unit 102 and estimates the position/orientation using a Visual Simultaneous Localization And Mapping (SLAM) method. The Visual SLAM method is a method for extracting feature points from an image, calculating a distance to each feature point by triangulation, and mapping the feature points on the space, whereby the self-position/orientation is estimated. The position/orientation estimation unit 104 may estimate the self-position by using not only the visual SLAM method for estimating the self-position based on a video image captured by a camera, but also a Light Detection And Ranging (LiDAR) SLAM method using a laser. The self-position may be estimated by a Depth SLAM method using a Time of Flight (ToF) sensor.

The position/orientation estimation processing may be performed using not only the Visual SLAM method, but also any other method, such as Visual Inertial SLAM that uses a combination of an IMU and an image.

The line-of-sight detection unit 105 is a line-of-sight obtaining unit that detects the line-of-sight direction of the user wearing the HMD 100 and identifies a point of gaze in a video image viewed by the user. Examples of the method for detecting the line of sight include a method of irradiating an eyeball of the user with an infrared ray from an infrared light-emitting portion incorporated in the HMD 100 and obtaining the line-of-sight direction of the user from an image obtained by an infrared camera incorporated in the HMD 100 based on a positional relationship between the position of the pupil and light reflected by the cornea.

A camera for obtaining an image to be used to detect the line of sight of the user may be used, and the camera may be attached to the inside of the HMD 100 to capture images of the eyes of the user when the user is wearing the HMD 100. The line-of-sight detection unit 105 detects the line of sight of the user wearing the HMD 100 and identifies a location on the display unit 109 where the user is gazing.

The subject detection unit 106 obtains an image captured by the imaging unit 102 and detects a subject from the image. In a case where it is determined that a predetermined subject is included in the image, the position and area of the subject are identified and the position and area of the subject are stored in the working memory 110 to be described below as subject information. As the position of the subject, the position of the subject within the space may also be identified by a method, such as triangulation.

The subject detection unit 106 detects a person or a moving object as a target subject. The subject detection processing may be performed by various methods, such as an object detection method using deep learning.

The image processing unit 107 generates a computer graphics (CG) object and performs rendering processing. Examples of the CG object include three-dimensional (3D) data prepared in advance, a window for browsing an image or a moving image, and a window for editing a document. To display such objects in a superimposed manner on the image captured by the imaging unit 102, the image processing unit 107 performs rendering processing using the position/orientation information estimated by the position/orientation estimation unit 104, and generates a CG image. The image processing unit 107 outputs CG information including information about the position and area of the CG object, and stores the CG information together with the CG image in the working memory 110.

The image combining unit 108 obtains the captured image obtained by the imaging unit 102 and the CG image and CG information generated by the image processing unit 107, and combines the captured image with the CG image and CG information to generate an output image for display. With this configuration, the MR space obtained by superimposing the CG image on the real space is expressed.

In the image combining processing, the combining method is determined using line-of-sight information detected by the line-of-sight detection unit 105, subject information detected by the subject detection unit 106, and the CG object generated by the image processing unit 107. The operation of the image combining unit 108 will be described in detail below.

The display unit 109 displays the image generated by the image combining unit 108. For example, the display unit 109 includes a display panel, such as a liquid crystal panel or an organic electroluminescence (EL) panel, and an eyepiece optical system for adjusting the size of an image displayed on the panel into an appropriate size for the user's eye. When the user wears the HMD 100, image display units are set in front of the respective eyes of the user.

The working memory 110 holds various data to be used for processing in each component of the HMD 100. For example, the working memory 110 holds the sensor information obtained by the orientation sensor unit 103, the position/orientation information estimated by the position/orientation estimation unit 104, and a tracking state.

The non-volatile memory 111 is an electrically erasable and recordable non-volatile memory, and stores applications to be executed by the control unit 101, various setting values, and the like.

A communication unit 112 includes, for example, an antenna for wireless communication, a modulator/demodulator circuit for processing wireless signals, and a communication controller to transmit and receive data to and from another device. The communication unit 112 outputs modulated wireless signals from the antenna, and demodulates wireless signals received through the antenna, whereby near-field communication compliant with Institute of Electrical and Electronics Engineers (IEEE) 802.15 standards (so-called Bluetooth®) is established. The communication unit 112 may be a wired communication unit, such as a universal serial bus (USB®) cable, or a wireless communication unit, such as Wireless Fidelity (Wi-Fi®). The communication unit 112 may transmit and receive data to and from a plurality of devices.

An operation unit 113 includes buttons. The operation unit 113 determines whether a button is operated, and transmits detected information to the control unit 101. The operation unit 113 may include various types of input forms.

An output unit 114 includes a light-emitting diode (LED) light source, a speaker, a vibration element, or the like.

### Description of Processing of Control Unit 101

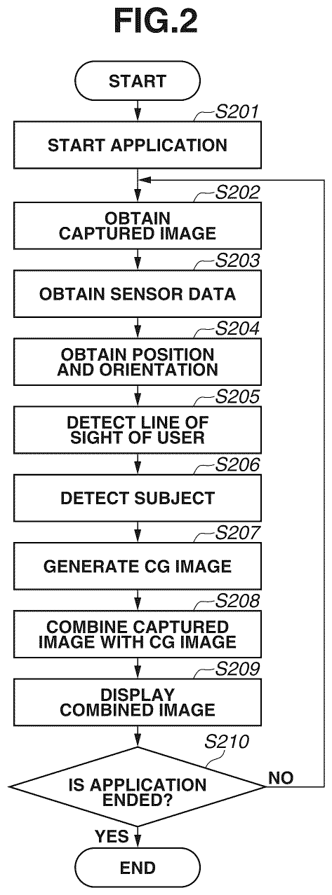

Processing to be performed by the control unit 101 will be described with reference to a flowchart illustrated in FIG. 2.

FIG. 2 is a flowchart illustrating processing of the control unit 101 that is performed from when the HMD 100 is activated to start an application to when the application is ended. The control unit 101 performs the processing according to the flowchart illustrated in FIG. 2, whereby the user experiences a virtual reality (VR) or MR space.

In step S201, the control unit 101 reads out execution data on the application stored in the non-volatile memory 111and starts the application. Then, the processing proceeds to step S202.

In step S202, the control unit 101 obtains an image captured by the imaging unit 102 and stores the obtained image in the working memory 110. Then, the processing proceeds to step S203.

In step S203, the control unit 101 obtains sensor data from the orientation sensor unit 103 and stores the obtained sensor data in the working memory 110. Then, the processing proceeds to step S204.

In step S204, the control unit 101 causes the position/orientation estimation unit 104 to start position/orientation estimation processing. After completion of the processing, the position/orientation estimation unit 104 stores the position/orientation information about the HMD, the generated space map information, and other additional information in the working memory 110. The other additional information includes the tracking state, images used to estimate the position/orientation, and time information about the orientation sensor unit 103. The control unit 101 stores the obtained various data in the working memory 110. Then, the processing proceeds to step S205.

In step S205, the control unit 101 causes the line-of-sight detection unit 105 to start to detect the line of sight of the user. In the line-of-sight detection processing, a point of gaze in the image obtained in step S202 is identified. The control unit 101 stores the detection result from the line-of-sight detection unit 105 in the working memory 110. Then, the processing proceeds to step S206. In a case of the information processing device not including the line-of-sight detection unit 105, the control unit 101 skips the processing of step S205 after the processing of step S204. Then, the processing proceeds to step S206.

In step S206, the control unit 101 causes the subject detection unit 106 to start subject position detection processing to detect the position of a subject in the image captured by the imaging unit 102. The control unit 101 stores information about the detected subject in the working memory 110. Then, the processing proceeds to step S207.

In step S207, the control unit 101 causes the image processing unit 107 to start generation of a CG image, i.e., an image of a virtual object. Then, the processing proceeds to step S208.

In step S208, the control unit 101 causes the image combining unit 108 to start image combining processing. The control unit 101 sets the transparency of the CG image by using latest data on the position/orientation information, the line-of-sight information, and the subject information stored in the working memory 110, and combines the captured image and the CG image in such a manner that the CG image is superimposed on the captured image, whereby a display image is generated. The control unit 101 stores the generated display image in the working memory 110. Then, the processing proceeds to step S209. Occlusion processing for occluding a CG image with a subject may be performed to factor in the depth of the subject in a 3D space in a case where the subject is in front of the CG image in the image combining processing.

In step S209, the control unit 101 displays the image generated in step S208 on the display unit 109. Then, the processing proceeds to step S210.

In step S210, the control unit 101 checks whether an application end instruction is issued by a user operation. In a case where the control unit 101 determines that the application end instruction is issued (YES in step S210), the processing of the application is ended. In a case where the control unit 101 determines that the application end instruction is not issued (NO in step S210), the processing returns to step S202.

As described above, the control unit 101 performs display control processing on the image to be displayed on the display unit 109.

### Description of Image Transparency Processing

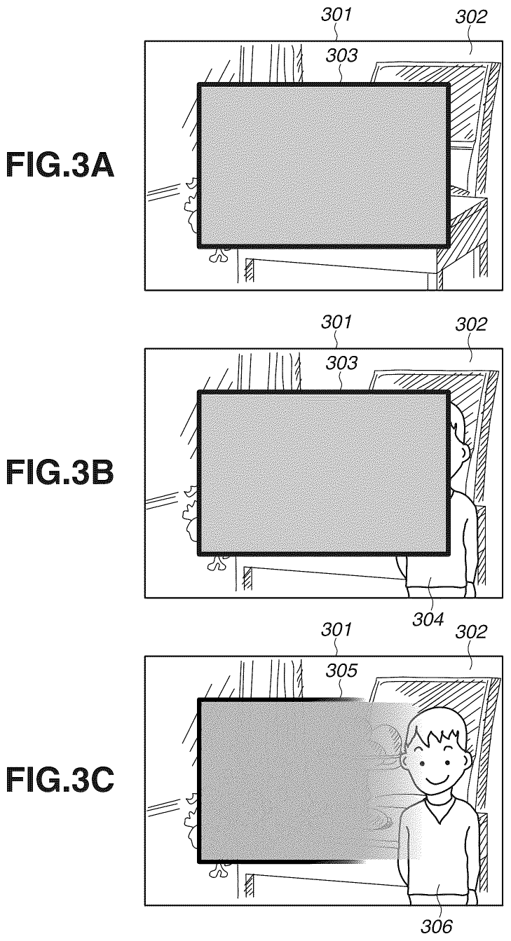

The processing performed by the image combining unit 108 in step S208 will be described in detail with reference to FIGS. 3A, 3B, and 3C.

FIG. 3A illustrates an image 301 that is generated by the image combining unit 108.

An image 302 is an image captured by the imaging unit 102. A virtual object 303 is a CG object generated by the image processing unit 107, and an application for, for example, viewing a video image or displaying a document is displayed. In other words, the user visually recognizes a combined image obtained by superimposing a virtual object on an image of the real space.

While the present exemplary embodiment illustrates an example where the virtual object 303 has a window shape for displaying application execution contents, the shape of the virtual object 303 is not limited to the window shape. The virtual object 303 may have any other shape.

The image combining unit 108 combines the image 302 with the virtual object 303 in such a manner that the image 302 is displayed as a background image and the virtual object 303 is displayed on the image 302.

The above-described processing is performed in real time, which provides the user with an experience that a CG image is displayed in the real space.

On the other hand, in a case where a person 304 is in the vicinity of the virtual object 303 as illustrated in FIG. 3B, there can be a case that it may be desirable to make the person visible even when the user currently uses the device.

To deal with such a case, the image combining unit 108 obtains subject information detected by the subject detection unit 106, changes the virtual object 303, which is superimposed on the person 304, to be in a transparent state, and superimposes the virtual object 303 on the captured image so that the user can visually recognize the person 304. The processing of displaying an object in a transparent state as described herein refers to processing of decreasing the visibility of the object. Examples of the processing include decreasing the display luminance of the object and the amount of projection light and increasing the transparency of the object, and adjusting the color of the object. Examples of the processing also include reducing the thickness of a line of a character object, and displaying a part of the object (including display of a mesh or dotted form). Alternative to the processing of displaying an object in a transparent state in the image combining unit 108, the image processing unit 107 may generate a virtual object obtained by the processing of setting the object in the transparent state, and the image combining unit 108 may perform the image combining processing of the generated virtual object on which the transparency processing has been performed.

In a case where the virtual object is a target to be subjected to the transparency processing, the image combining unit 108 sets the transparency of an area of a CG object 305 corresponding to a subject 306 so that the subject 306 is visible to the user, and combines the CG object 305 with the image 302 which is a background image, as illustrated in FIG. 3C.

Determination of whether to display the subject 306 through the CG object may be performed such that in a case where the distance to the subject 306 from the user is within a predetermined distance, the subject 306 is displayed through the CG object. Instead of setting a person as the subject 306 as described above, any other moving object, such as an animal kept as a pet, may be set as the subject.

While FIG. 3C illustrates an example of processing of setting an area corresponding to the subject (person) to the transparent state, the virtual object 303 may be entirely displayed in the transparent state. The transparency may be set such that the transparency of the virtual object is partially changed while the entire virtual object is displayed in the transparent state, and the entire virtual object may set to a certain transparency. The transparency processing may be started in response to the subject approaching the user.

With the above-described configuration, the user can communicate with another person without being visually disturbed by the virtual object when the other person is approaching the user, or when the other person is talking to the user.

### Screen Example after Virtual Object is Displayed in Transparent State

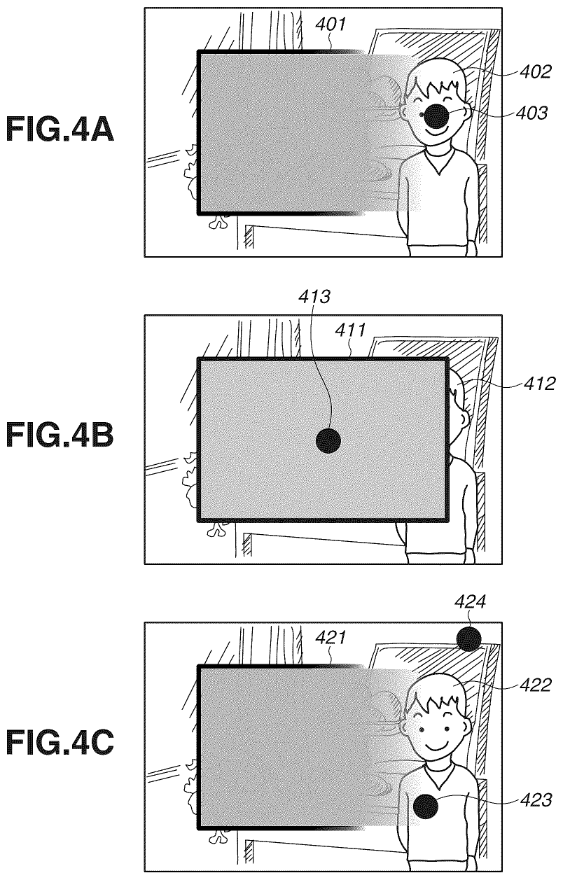

In a state in which the virtual object is displayed in the transparent state so that the subject is visible to the user by the above-described processing, there can be a case that the user desires to cancel the transparent state and continue the operation, depending on the use situation. Processing to be performed by the image combining unit 108 in such a situation will be described in detail with reference to FIGS. 4A, 4B, and 4C.

FIG. 4A illustrates a state where a virtual object 401 is displayed in the transparent state and a person 402 in the vicinity of the user is visible to the user. A point of gaze 403 of the user is displayed as a solid black circle. For example, in a case where the user is gazing at the subject, the virtual object may be displayed in the transparent state as indicated by the virtual object 401 illustrated in FIG. 4A. However, in a case where the user desires to continue an operation of operating the virtual object, for example, it may be desirable for the user to display the virtual object in an opaque state.

FIG. 4B illustrates an example of the image that is visually recognized by the user with the virtual object being displayed in the opaque state in the state illustrated in FIG. 4A.

The image combining unit 108 determines whether to cancel the transparent state based on the point of gaze of the user detected by the line-of-sight detection unit 105, the subject information detected by the subject detection unit 106, and the CG image and CG information generated by the image processing unit 107. For example, in a case where the point of gaze of the user is on the virtual object and is not on the area where a person 412 is present as a result of the movement of the line of sight of the user from the point of gaze 403 illustrated in FIG. 4A to a point of gaze 413 illustrated in FIG. 4B, it is determined that the user's attention is focused on the virtual object. In such a case, the virtual object is set in the opaque state as indicated by a virtual object 411. Thus, the CG area that has been invisible due to the transparent state is displayed in the opaque state so that the CG area is visually recognizable by the user. With this configuration, the user can continue the operation without being visually disturbed by the transparent state.

Depending on the use situation, it may be desirable for the user to maintain the transparent state.

FIG. 4C illustrates an example of the image that is visually recognized by the user with the virtual object being maintained in the transparent state illustrated in FIG. 4A.

In a case where the point of gaze of the user is on the transparent virtual object and is also on a person 422, which is in the position behind the virtual object, as indicated by a point of gaze 423 as a result of the movement of the point of gaze of the user from the state illustrated in FIG. 4A, it can be considered that the user is gazing at the person 422 and thus it is able to be determined that the user's attention is focused on the person 422. Accordingly, the image combining unit 108 maintains the transparent state of the virtual object as indicated by a virtual object 421. In the above-described way, since the transparent state is maintained, the user can continuously communicate with a communication partner without being visually disturbed by the virtual object. In addition to maintaining the transparent state of the virtual object, the transparency of the virtual object may be increased. For example, the transparency of the virtual object may be further increased, or the area of the virtual object to be displayed in the transparent state may be increased. In a case where determination of whether the user is looking at a virtual object or a person is able to be performed based on the depth of the subject, an angle of convergence or the like may be used. In a case where determination of whether the user is looking at a virtual object or a person is able to be performed, processing of changing the transparency or processing of maintaining the transparency may be performed in accordance with the information.

In a case where the point of gaze of the user has moved to a position indicated by a point of gaze 424 as a result of the movement of the point of gaze of the user from the state illustrated in FIG. 4A, it is able to be considered that the user's attention is focused on an object other than the virtual object or the person. In this case, it is difficult to determine on which one of the person and the virtual object the user's attention is focused. Thus, the image combining unit 108 maintains the transparency of the virtual object 421 to prevent the transparent state of the virtual object from being frequently switched, which disturbs the visibility.

### Screen Example when Person is Hidden Behind Virtual Object in Opaque State

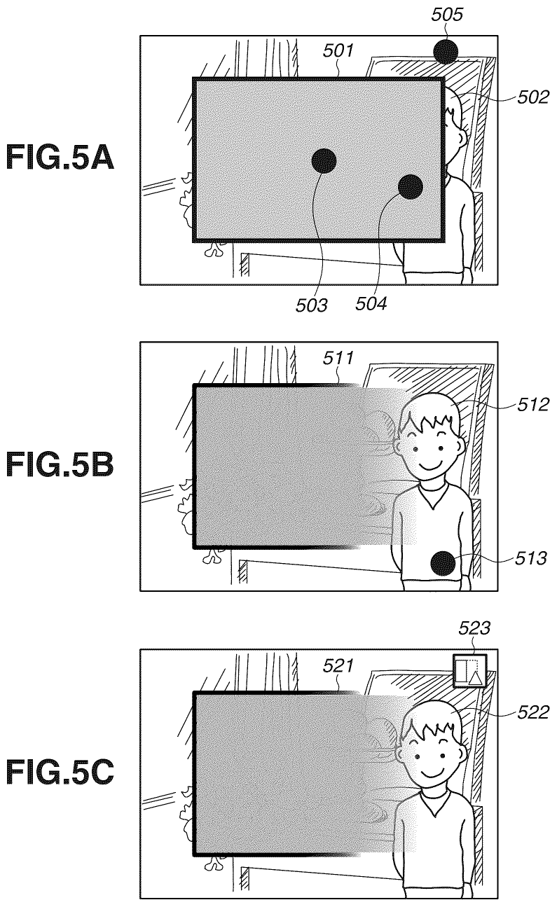

FIG. 5A illustrates a state where a person 502 is hidden behind a virtual object 501 because the virtual object 501 is displayed in the opaque state.

In a case where the point of gaze of the user is in the position of a point of gaze 503, the point of view of the user is on the area of the virtual object 501 and is not on the area of the person. Thus, the virtual object 501 is displayed in the opaque state.

In a case where the point of gaze of the user has moved from the point of gaze 503 to the position of a point of gaze 504, the point of gaze 504 is on the virtual object and is also on the area of the person 502.

In such a situation, since the user has looked at the virtual object at the point of gaze 503, it is able to be determined that the user's attention is focused on the virtual object 501 in a case where the point of gaze of the user has moved to the position of the point of gaze 504.

For this reason, the image combining unit 108 maintains the opaque state of the virtual object as indicated by the virtual object 501. In other words, the transparency of the virtual object is not increased.

In a case where the point of view of the user has moved to the position of a point of gaze 505, it is difficult to determine which one of the person and the virtual object the user's attention is focused on after that. Thus, the image combining unit 108 maintains the opaque state of the virtual object.

However, in a case where the point of gaze of the user has moved to an area where the person is not hidden behind the CG image as illustrated in FIG. 5A, it is able to be determined that the user's attention is focused on the person. Thus, it may be desirable for the user to display the virtual object in the transparent state.

FIG. 5B illustrates an example of the image that is visually recognized by the user with the virtual object being displayed in the transparent state from the state illustrated in FIG. 5A.

In a case where the line of sight of the user has moved and the point of gaze of the user has moved to a position indicated by a point of gaze 513, the point of gaze 513 is on an area of a person 512. Thus, the image combining unit 108 displays a virtual object 511 in the transparent state so that the person 512 is visible to the user.

FIG. 5C illustrates an example of the image that is visually recognized by the user with the virtual object being displayed in the transparent state in the state illustrated in FIG. 5A.

As another method for displaying the virtual object in the transparent state so that the person is visible from the state illustrated in FIG. 5A, a user interface (UI) for explicitly changing the transparent state of the virtual object may be displayed.

In some cases, the virtual object is displayed in the opaque state as illustrated in FIG. 5A, and the person is completely hidden behind the virtual object. In such a case, displaying the virtual object in the transparent state so that the person is visible to the user by using the method described above with reference to FIG. 5B is difficult. Thus, a UI for operation is displayed as indicated by a virtual object 523.

The virtual object 523 is a UI that is displayed on the screen when the person is hidden behind the virtual object, and functions as a discrimination unit for the user to explicitly designate the transparent state.

In this case, in response to the point of gaze of the user moving onto the virtual object 523 (point of gaze is not illustrated), the state of a virtual object 521 is changed to the transparent state so that a person 522 is visible to the user.

The virtual object 523 may be displayed in a case where, for example, the person is completely hidden behind the virtual object 501 and the line of sight of the user cannot be moved onto the person.

The virtual object 523 may be displayed in response to the user visually recognizing the person in the captured image. The virtual object 523 may be constantly displayed, and in a case where the person is hidden behind the virtual object, the display content may be changed to inform the user that the person is present in the vicinity of the user. The virtual object 523 may be constantly displayed, and in a case where the person is hidden behind the virtual object, a notification indicating that the person is in the vicinity of the user may be transmitted to the user using a sound, a vibration, or the like.

### Screen Example when Virtual Object is Displayed in Transparent State and Point of Gaze has Moved from Area other than Virtual Object and Person

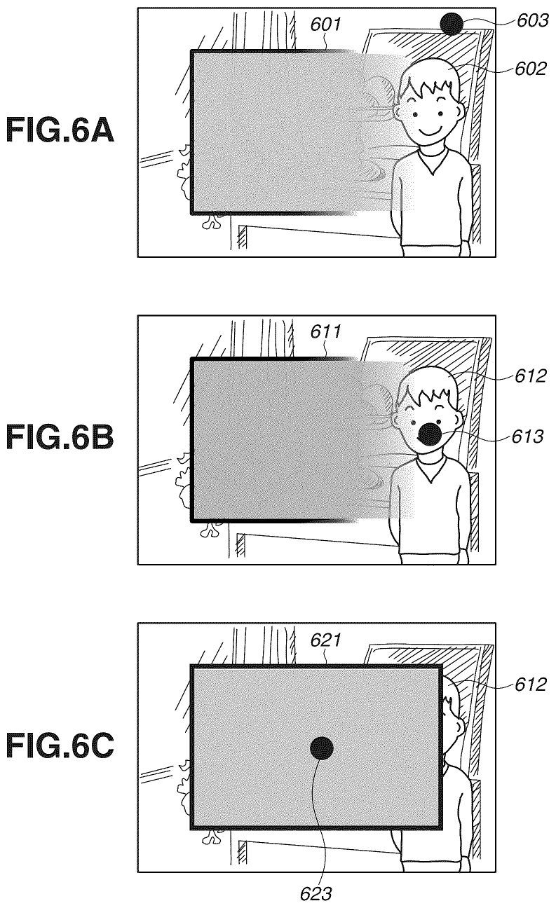

Examples of images visually recognized by the user when the line of sight of the user has moved onto a person from an area other than the virtual object and the person in a state where the virtual object is displayed in the transparent state will be described with reference to FIGS. 6A, 6B, and 6C.

FIG. 6A illustrates an example of an image that is visually recognized by the user in a state where a virtual object 601 is set in the transparent state and a person 602 is visible to the user. A point of gaze 603 indicates that the user is visually recognizing an area other than the virtual object 601 and the area of the person 602.

FIG. 6B illustrates an example of the image that is visually recognized by the user in a case where the point of gaze of the user has moved onto a person 612 from the state illustrated in FIG. 6A.

From a state of the point of gaze of the user being on an area other than the virtual object and the person as indicated by the point of gaze 603, in a case where the line of sight of the user has moved onto the person 612 as indicated by a point of gaze 613 illustrated in FIG. 6B, it is able to be determined that the user's attention is focused on the person. Thus, the image combining unit 108 performs image combining processing to maintain the transparent state of the virtual object as indicated by a virtual object 611. The virtual object 611 may be displayed with higher transparency than the transparency of the virtual object 601. For example, the transparency of the virtual object 611 may be simply increased, or the area of the virtual object 611 in the transparent state may be increased.

FIG. 6C illustrates an example of the image that is visually recognized by the user in a case where the line of sight of the user has moved to a position that is on the virtual object and is not on the person 612 as indicated by a point of gaze 623 from the state illustrated in FIG. 6A. In such a case, it is able to be determined that the user's attention is focused on a virtual object 621. Thus, the image combining unit 108 performs image combining processing by setting the virtual object in the opaque state as indicated by the virtual object 621.

All the processing described above with reference to FIGS. 4A to 6C may be implemented, or certain processing in the processing described above with reference to FIGS. 4A to 6C may be implemented.

While the present exemplary embodiment illustrates an example where a person is set as the subject, any other moving object, such as an animal kept as a pet, may be set as the subject.

An example where the subject is detected from an image is described above as subject detection processing. After the subject is detected from an image, detection of the line of sight or voice of the detected person is further performed, and determination of whether the line of sight or voice of the detected person is directed to the user may be performed, to use the determination result as the subject detection processing result. The device according to the present exemplary embodiment may be provided with a unit for registering a predetermined person in advance, and in a case where the detected subject is a person, the determination result may be included in the subject detection processing result when the person matches the preliminarily registered person.

A movement of a line of sight is generally unstable, and thus a spatial or temporal allowance may be set for determination of the position of the line of sight of the user in the line-of-sight detection processing in the line-of-sight detection unit 105.

For example, in the case of determination of whether the line of sight of the user is on a person, it may be determined that the line of sight of the user is on the person as long as the point of gaze of the user is in a predetermined area in the vicinity of the person. Instead of performing the determination immediately when the point of gaze has moved, the determination may be performed after a lapse of a predetermined period of time.

A depth of gaze may be detected based on the angle of convergence between the eyes of the user, and the point of gaze in the space may be determined.

While the present exemplary embodiment illustrates an example where the virtual object is displayed in the opaque state, the transparency may be decreased without setting the virtual object completely opaque.

A unit for transmitting a notification in accordance with the transparent state may be disposed on the outside of the HMD 100 so that a person in the vicinity of the user can recognize whether the user of the HMD 100 is looking at the person. For example, a display that is disposed on the outside of the HMD 100, or on the opposite side of the displays in front of the user's eyes may be used to transmit a notification so that the person in the vicinity of the user can recognize that the user of the HMD 100 is looking at the person. Even when the user of the HMD 100 is not looking at the person, a notification may be transmitted to the person in the vicinity of the user so that the person in the vicinity of the user can recognize that the user is looking at the user. For example, an LED may be disposed to emit light when the user is visually recognizing a person.

### Flowchart of Processing for Displaying Virtual Object in Transparent State

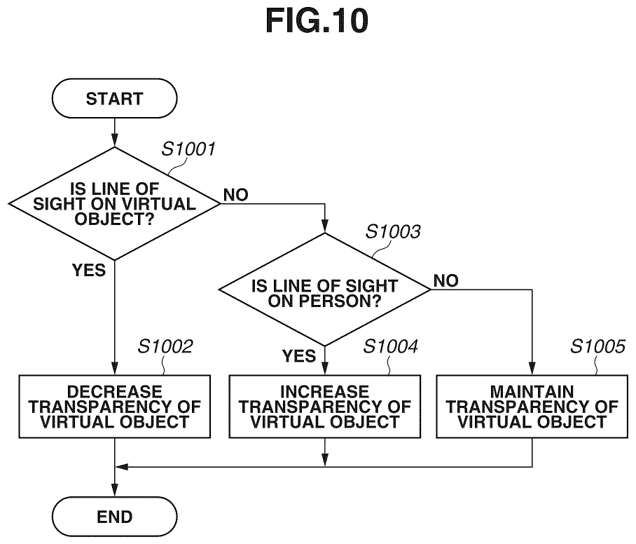

A procedure of processing performed in step S208 illustrated in FIG. 2 will be described with reference to a flowchart illustrated in FIG. 10. Instead of performing the processing in step S208, the processing illustrated in FIG. 10 may be performed in step S207 illustrated in FIG. 2. In the present exemplary embodiment, the procedure starts in the scene where the subject is detected and the transparency of the virtual object is increased. Processing of the following flowchart is started in a scene where the subject is detected before this processing is started and the transparency of the virtual object is already increased.

In step S1001, the control unit 101 determines whether the line of sight detected in step S205 is on the virtual object. In a case where the control unit 101 determines that the line of sight is on the virtual object (YES in step S1001), the processing proceeds to step S1002. In a case where the control unit 101 determines that the line of sight is not on the virtual object (NO in step S1001), the processing proceeds to step S1003. Instead of factoring in the depth, the determination may be performed based on the position of the line of sight in a two-dimensional image, or based on the position of the line of sight in a three-dimensional image.

In step S1002, the control unit 101 decreases the transparency of the virtual object where the line of sight is directed, or sets the state of the virtual object to be closer to the opaque state. Then, the processing ends. The virtual object may be set to be completely opaque, or the transparency of the virtual object may be decreased while the virtual object is displayed in the transparent state. Processing of decreasing the area of the virtual object that is displayed in the transparent state may be performed. In a case where the area of the virtual object that is displayed in the transparent state is gradually decreased, an advantageous effect of preventing the visual field of the user from being suddenly switched is provided.

In step S1003, the control unit 101 determines whether the line of sight is on a person in a background image. In a case where the control unit 101 determines that the line of sight is on the person (YES in step S1003), the processing proceeds to step S1004. In a case where the control unit 101 determines that the line of sight is not on the person (NO in step S1003), i.e., the control unit 101 determines that the line of sight is on the background image other than the area of the person, the processing proceeds to step S1005. In this case, the person in the background image corresponds to the subject detected in step S206.

In step S1004, the control unit 101 increases the transparency of the virtual object where the line of sight is directed so that the person is more visually recognized, and then terminates the processing. In a case where the virtual object is already set completely transparent, or in a case where the transparency of the virtual object is increased to the transparency preliminarily set by the user, the control unit 101 controls the transparency to be maintained. Alternatively, the transparency of the area overlapping the person may be increased, or the area that is displayed in the transparent state may be increased.

In step S1005, the control unit 101 maintains the transparency of the virtual object, and then terminates the processing. Since the line of sight is not on the person, the transparency of the virtual object may be decreased. In the processing illustrated in FIG. 10, since it is difficult to determine the user's intention because the line of sight is on an area other than the virtual object and the person, the transparency is maintained. However, since the line of sight is not on the person, it may be determined that there is no need to set the person visible and the transparency of the virtual object may be decreased. Since the user is looking at the real space image in the background, the transparency of the virtual object may be increased or the area of the virtual object that is displayed in the transparent state may be increased to prevent the virtual object from disturbing the user.

In step S1001, the determination may be performed based on how the line of sight has moved from a previous point of time prior to a predetermined point of time, instead of the position of the line of sight in the captured image at the predetermined point of time.

A degree of change in transparency may be changed in accordance with the movement of the line of sight. For example, in a case where the user is continuously looking at the virtual object from the previous point of time, the degree of change may be increased so that the transparency of the virtual object is further decreased. For example, at the previous point of time, the line of sight has been on the person, and in a case where the line of sight has moved to the virtual object at the predetermined point of time, the transparency of the virtual object may be slightly decreased to decrease the degree of change.

While FIG. 10 illustrates processing in a case where the subject is detected and the transparency of the virtual object is already increased, the processing illustrated in FIG. 10 may be performed such that increasing the transparency is not performed at the time of when the subject is detected, and the transparency is increased in a case where the line of sight of the user is moved onto the person, a part of which is visible.

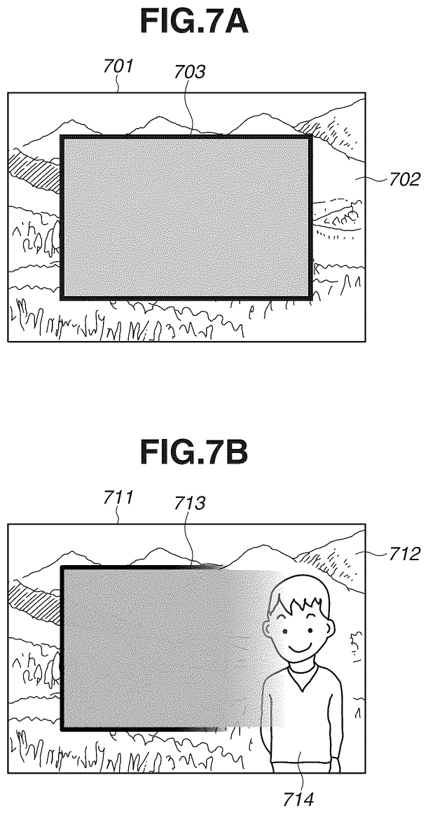

An example of an image that is visually recognized by the user using an information processing device according to a second exemplary embodiment of the present disclosure will be described below with reference to FIGS. 7A and 7B. A system according to the second exemplary embodiment is a system for the information processing device that operates in a VR mode.

A basic configuration of the information processing system according to the second exemplary embodiment is similar to that of the first exemplary embodiment, except for processing that is performed by the image combining unit 108.

FIG. 7A illustrates an example of a display image in the VR mode. FIG. 7A illustrates a state where an image 701 is generated by the image combining unit 108, and the user cannot visually recognize the image of the real space. The image 701 is generated by superimposing a virtual object 703 on a background CG image 702.

The background CG image 702 is an example of a displayed background image that is prepared in advance and is recorded on the non-volatile memory 111. Using another image different from the image of the space in which the user is present enables the user to experience as if the user has moved to a different space in a pseudo manner.

The background image that is used is not limited to a recorded background image, but instead may be a CG image that varies in real time in accordance with the situation. As the background image, an image recorded on an external device (server etc.) may be obtained through the communication unit 112.

The virtual object 703 is a virtual object generated by the image processing unit 107, and an application for, for example, viewing a video image or displaying a document is displayed. Also, in the present exemplary embodiment, similar to the first exemplary embodiment, the virtual object 703 may be set in any shape.

The above-described processing is performed in real time, which enables the user to experience a video image in which a CG image is displayed in the virtual space.

In the VR mode according to the present exemplary embodiment, images captured by the imaging unit 102 are not used in the normal use, and thus the surroundings of the user in the real space is not visible to the user.

FIG. 7B illustrates an example of the image that is visually recognized by the user when a person is detected in the vicinity of the user in the subject detection processing performed by the subject detection unit 106 when the surroundings of the user in the real space is not visible.

In a case where a person is detected by the subject detection unit 106, the image combining unit 108 obtains the area of the person detected by the subject detection unit 106. The image combining unit 108 sets the transparency of each area of the background image and the virtual object corresponding to the obtained area of the person, and combines the generated image with the captured image obtained by the imaging unit 102.

As a result, a person 714 is displayed through a background image 712 and a virtual object 713, so that the user can visually recognize the person in the vicinity of the user.

The determination of whether to display the subject, i.e., the person 714, through the background image and the virtual object may be performed such that in a case where the distance from the subject is within a predetermined distance from the HMD 100, the subject is displayed through the background image and the virtual object. In the determination of whether to display the subject through the background image and the virtual object, determination of whether the subject is talking may be performed or the direction of the body or face of the subject may be detected, in addition to the subject detection processing. Determination of whether the subject is moving his or her mouse, or whether the subject has opened his or her mouse may also be performed, or the line of sight of the subject may be detected. The determination of whether to display the subject through the background image and the virtual object may also be performed based on the behavior of the subject, for example, based on whether the subject is walking, is stopped, or is performing some operation. For example, in a case where the line of sight of the subject or the body, face, or the like of the subject is directed to the user, and the subject is moving his or her mouse with a gesture, the image may be processed to display the subject through the background image and the virtual object. The determination of whether to display the subject through the background image and the virtual object may be performed by using a combination of the above-described methods, as needed, or using at least one of the methods.

### Screen Example based on Point of Gaze in a case where Virtual Object is Displayed in Transparent State in VR Mode

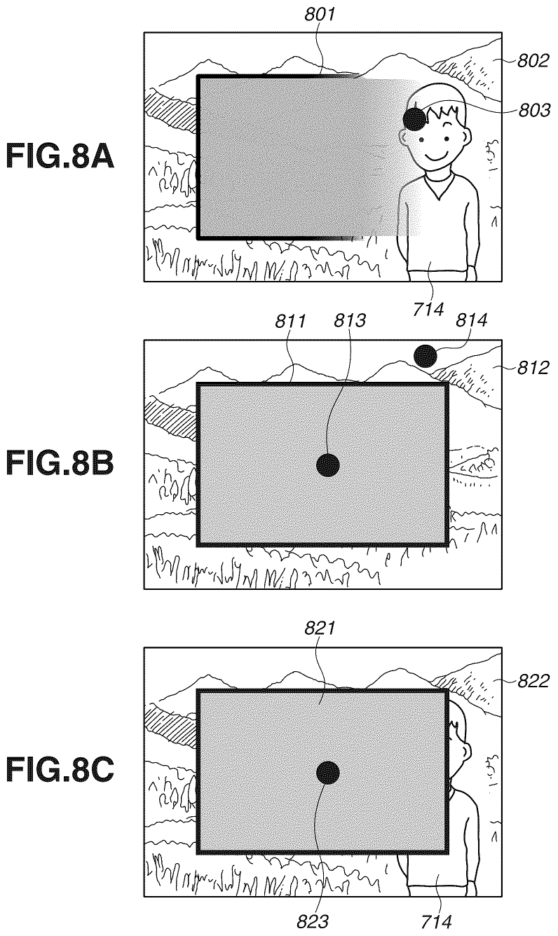

A screen example based on the point of gaze of the user after the virtual object is displayed in the transparent state in the VR mode will be described with reference to FIGS. 8A, 8B, and 8C.

FIG. 8A illustrates an example of an image in a state where a person in the vicinity of the user is displayed through the background image and the virtual object.

In this case, in a case where the line of sight of the user is on the person 714 which has been detected, the transparent state of each of the virtual object and the background image is maintained as indicated by a virtual object 801 and a background image 802. Even in a case where the line of sight of the user is on the virtual object as indicated by a point of gaze 803, in a case where the line of sight is on the person 714, which is visible to the user through the virtual object and the background image, the transparent state as illustrated in FIG. 8A is maintained.

FIG. 8B illustrates processing for setting the opaque state from the state illustrated in FIG. 8A.

As indicated by a point of gaze 813, in a case where the line of sight of the user is on a virtual object 811 and is on a position other than the person that is visible to the user through the virtual object and the background image, the virtual object and the background image are set in the opaque state as indicated by the virtual object 811 and a background image 812. As described above with reference to FIG. 7B, in a case where the subject is detected again, the person may be displayed again through the virtual object and the background image. Once the state is changed from the transparent state to the opaque state, the subject may be prevented from being displayed through the virtual object and the background image for a predetermined period of time. As described below, once the state is changed to the opaque state from the transparent state, as illustrated in FIG. 8C, a transparent state different from the previous transparent state may be set. For example, the transparency may be decreased from the previously set transparency, or the area of the virtual object to be displayed in the transparent state may be decreased.

In a case where a plurality of virtual objects is present, some of the virtual objects may be displayed in the transparent state, and the other virtual objects may be displayed in the opaque state, or the CG image may be displayed in the transparent state as a background image.

In the VR mode according to the present exemplary embodiment, the background image that is originally visible to the user as illustrated in the example of FIG. 8A is hidden. Accordingly, in a case where the line of sight of the user has moved onto a position on the background image 802, more specifically, in a case where the line of sight of the user has moved to a point of gaze 814, it is able to be determined that the user wishes to check the background image. Thus, the image combining unit 108 may set the background image in the opaque state to hide the person even in a case where the line of sight of the user is not on the virtual object 811 but, for example, is on the point as indicated by the point of gaze 814.

As illustrated in FIG. 8C, in a case where the line of sight of the user is on the virtual object 811 as indicated by a point of gaze 823 and is not on the person 714, the image combining unit 108 may display a virtual object 821 in the opaque state and may maintain the transparent state of a background image 822. In other words, with the display of the person 714 as illustrated in FIG. 8C, the presence of the person 714 is visually indicated to the user.

### Screen Example in a case where Transparency is Set based on Distance from Virtual Object and Person to Line of Sight in VR Mode

While an example where the transparency is set using the transparent state and the opaque state in the processing of the image combining unit 108 according to the present exemplary embodiment is described above, the transparency may be set based on the distance from a virtual object and a person to the line of sight of the user.

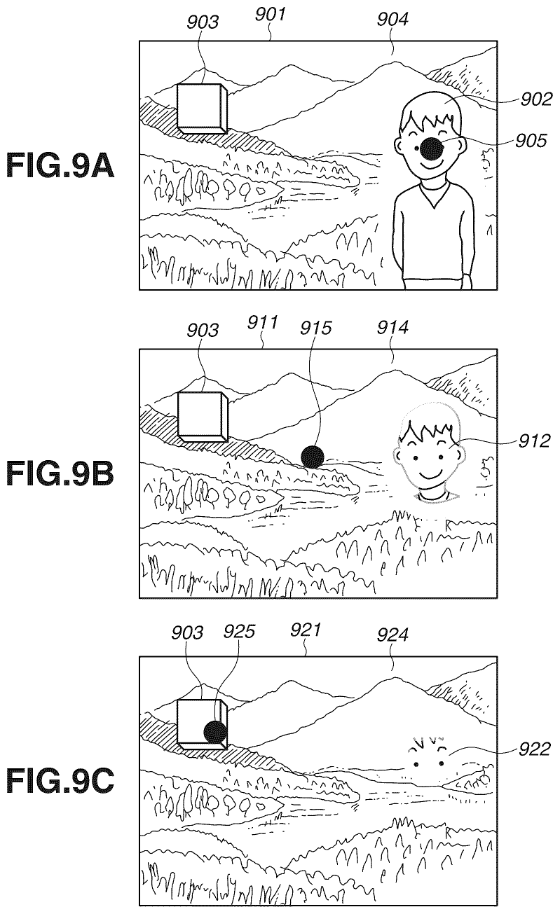

FIGS. 9A to 9C each illustrate processing that is performed by the image combining unit 108 as described above.

FIG. 9A illustrates a combined image 901, a person 902 in the vicinity of the user, a virtual object 903, and a background image 904. In this case, the person 902 is displayed through the background image 904. In a case where the line of sight of the user is on the person 902 as indicated by a point of gaze 905, the image combining unit 108 sets each of the virtual object903 and the background image 904 in the transparent state as described above so that the user can see the person 902.

In a case where the line of sight of the user is moved, the transparency of each of the virtual object and the background image is set such that the degree of transparency with respect to the person is determined based on the distance between the line of sight and the person and the distance between the line of sight and the virtual object.

FIG. 9B illustrates a combined image 911 in which a point of gaze 915 is at the midpoint between the virtual object 903 and a person 912.

Unlike in the state of FIG. 9A where the entire area of the person is visible to the user, in the example of FIG. 9B, the transparency of each of the virtual object 903 and a background image 914 is set to be half transparent with respect to the person as indicated by the person 912.

In the example of FIG. 9B, the transparency is increased from the periphery of the area corresponding to the person. Alternatively, the entire area corresponding to the person may be displayed with uniform transparency in accordance with the distance.

FIG. 9C illustrates a combined image 921 in which the line of sight of the user has further moved and the line of sight of the user is on the virtual object 903 as indicated by a point of gaze 925. An opaque area in a background image 924 illustrated in FIG. 9C is wider than that in the background image 914 illustrated in FIG. 9B. In this case, the image combining unit 108 may set the transparency of each of the virtual object 903 and the background image 914 to the completely opaque state, or may decrease the transparency to about the transparency with which the user can visually recognize the presence of a person 922, without setting the completely opaque state.

Each of the distance between the line of sight and the person and the distance between the line of sight and the virtual object may be determined to be a shortest distance, or may be determined to be a distance from arbitrary point.

The present disclosure has been described in detail above with reference to preferred exemplary embodiments. However, the present disclosure is not limited to these specific exemplary embodiments, and various modes without departing from the gist of the present disclosure are also included in the present disclosure. Some of the above-described exemplary embodiments may be combined as appropriate.

### Flowchart of Processing for Displaying Virtual Object in Transparent State in VR Mode

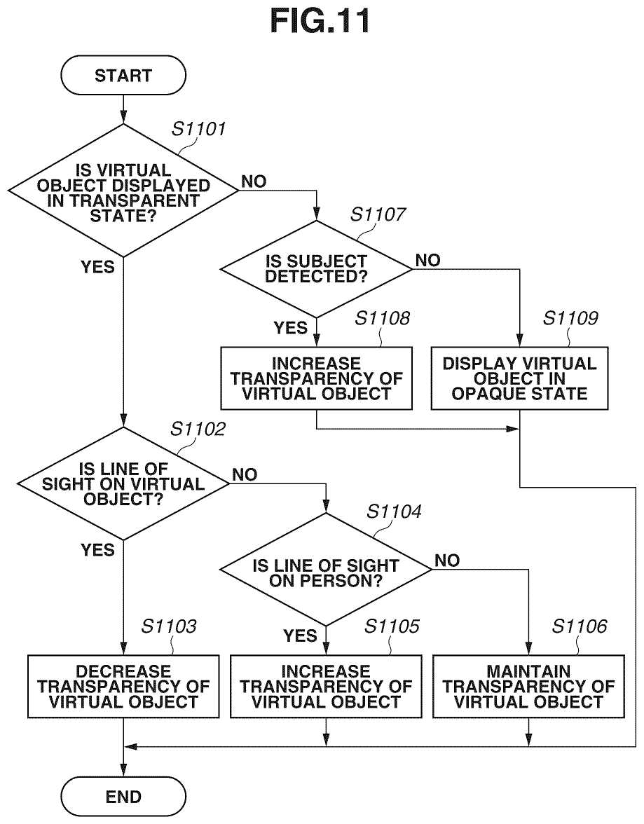

A procedure of processing performed in step S208 illustrated in FIG. 2 will be described with reference to a flowchart illustrated in FIG. 11. Instead of performing the processing in step S208, the processing illustrated in FIG. 11 may be performed in step S207 illustrated in FIG. 2. Since the processing in the flowchart illustrated in FIG. 11 is performed in the VR mode, a description will be given of a case where the background image and the virtual object are not displayed in the transparent state in a normal operation.

In step S1101, the control unit 101 determines whether the virtual object is displayed in the transparent state in the image generated immediately before. The information processing device according to the present exemplary embodiment estimates the position and orientation of the information processing device, for example, every time the imaging unit 102 obtains a captured image, generates an image of a virtual space, and displays the generated image on the display unit 109. At a predetermined point of time, in the case of generating an image of a virtual space, determination processing to be subsequently performed is different between a case in which a CG image has been displayed in the transparent state in the image generated immediately before and a case in which the CG image has not been displayed in the transparent state. In a case where the control unit 101 determines that the virtual object has been displayed in the transparent state in the image generated immediately before, the processing proceeds to step S1102. In a case where the control unit 101 determines that the virtual object has not been displayed in the transparent state in the image generated immediately before, the processing proceeds to step S1107. In this processing, the image generated immediately before may be stored in the working memory 110. In this case, the control unit 101 reads out the image that is generated immediately before and stored in the working memory 110, and performs the determination processing in step S1101.

In step S1102, the control unit 101 determines whether the line of sight is on the virtual object. In a case where the control unit 101 determines that the line of sight is on the virtual object (YES in step S1102), the processing proceeds to step S1103. In a case where the control unit 101 determines that the line of sight is not on the virtual object (NO in step S1102), the processing proceeds to step S1104. Instead of factoring in the depth, the determination may be performed based on the position of the line of sight in a two-dimensional image, or the position of the line of sight in a three-dimensional image. In this case, in the processing of step S1102, in a case where the line of sight is on the image of the virtual space serving as the background image, the control unit 101 determines that the line of sight is not on the virtual object.

In step S1103, the control unit 101 decreases the transparency of the virtual object where the line of sight is directed, more specifically, sets the virtual object to be in a state closer to the opaque state, and then terminates the processing. The virtual object may be displayed in the completely opaque state, or the transparency may be decreased while the virtual object is displayed in the transparent state. Processing of decreasing the area of the virtual object to be displayed in the transparent state may be performed. Using a method in which the area of the virtual object to be displayed in the transparent state is gradually decreased provides an advantageous effect of preventing the visual field of the user from being suddenly switched.

The transparency of only the virtual object may be changed, and the transparency of the background image may be decreased while the transparency of the virtual object is decreased. The virtual object and the background image may be displayed with the same transparency or different transparencies.

In step S1104, the control unit 101 determines whether the line of sight is on the person in the background image. In a case where the control unit 101 determines that the line of sight is on the person (YES in step S1104), the processing proceeds to step S1105. In a case where the control unit 101 determines that the line of sight is not on the person (NO in step S1104), more specifically in a case where the control unit 101 determines that the line of sight is on the image of the virtual space serving as the background image other than the area of the person, the processing proceeds to step S1106. In this case, the person in the background image corresponds to the subject detected in step S206.

In step S1105, the control unit 101 increases the transparency of the virtual object where the line of sight is directed so that the person is more visually recognized, and then terminates the processing. In a case where the virtual object is already set to be completely transparent, or in a case where the transparency of the virtual object is increased to the transparency preliminarily set by the user, the transparency is controlled to be maintained. The transparency of an area overlapping the area of the person may be increased, or the area of the virtual object to be displayed in the transparent state may be increased. Not only the transparency of the virtual object, but also the transparency of the background image of the virtual space may be increased. In the case of displaying the image in the transparent state, the transparency of the image may be increased toward the face of the person, and the transparency of the real space around the person serving as the background portion may be decreased, or the background portion may be displayed in a relatively opaque state.

In step S1106, the control unit 101 maintains the transparency of the virtual object, and then terminates the processing. In the processing of step S1106, while the background image corresponds to the image of the real space in the processing of FIG. 10, the background image corresponds to the image of the virtual space in the processing of FIG. 11. Thus, in step S1106, the control unit 101 determines that it is difficult to determine the user's intention because the line of sight is on an area other than the virtual object and the person as described above, and the transparency of each of the virtual object and the background image may be maintained. The transparency of each of the virtual object and the background image may be decreased based on the determination that the user wishes to view the background of the virtual space.

In step S1107, the control unit 101 determines whether the subject has been detected in step S206. In a case where the control unit 101 determines that the subject has been detected in step S206 (YES in step S1107), the processing proceeds to step S1108. In a case where the control unit 101 determines that the subject has not been detected in step S206 (NO in step S1107), the processing proceeds to step S1109.

The control unit 101 may determine whether the subject is detected from the captured image of the real space stored in the working memory 110 in step S1107. In such a case, step S206 may be skipped.

Instead of performing the determination as to whether the subject has been detected, the determination may be performed based on whether the subject is approaching the user, or the determination may be performed based on whether the subject is talking to the user. For example, in a case where the subject is approaching the user, the transparency of the virtual object is increased, and in a case where the subject is talking to the user, the transparency of the virtual object is increased.

In step S1108, the control unit 101 increases the transparency of the virtual object, and then terminates the processing. Not only the virtual object, but also the background image of the virtual space is displayed in the transparent state. The virtual object and the background image of the virtual space may be displayed with the same transparency or different transparencies. For example, the background image of the virtual space may be displayed in the transparent state, and the background area overlapping the subject may be set such that the area cannot be visually recognized by the user and the virtual object can be slightly visually recognized by the user.

In step S1109, the control unit 101 displays the virtual object and the background image in the opaque state, and then terminates the processing.

According to an aspect of the present disclosure, a more user-friendly information processing device capable of reflecting the intention of a user is able to be provided.

### Other Embodiments

Embodiment(s) of the present Disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc™ (BD)), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-010768, filed Jan. 29, 2024, which is hereby incorporated by reference herein in its entirety.

What is claimed is:

1. An information processing device comprising:
a processor; and
a memory storing a program which, when executed by the processor, causes the information processing device to:
execute image obtaining processing to obtain a captured image;
execute line-of-sight obtaining processing to obtain a line of sight of a user; and
execute display control processing to display a combined image obtained by combining the captured image with a virtual object on a display,
wherein in the display control processing, transparency of the virtual object overlapping an area of a person included in the captured image is determined based on the line of sight of the user.

2. The information processing device according to claim 1, wherein in the display control processing, in a case where the virtual object and a moving object included in the captured image obtained in the image obtaining processing overlap each other as viewed from the user, transparency of at least a part of an area of the virtual object overlapping the moving object is increased, and then the transparency of the virtual object with the increased transparency is further determined based on the line of sight of the user obtained in the line-of-sight obtaining processing.

3. The information processing device according to claim 2, wherein in the display control processing, in a case where the line of sight is on the person for a predetermined period of time, the transparency of the virtual object with the increased transparency is further increased or maintained.

4. The information processing device according to claim 2, wherein in the display control processing, in a case where the line of sight is on the area of the virtual object for a predetermined period of time, the transparency of the virtual object with the increased transparency is decreased.

5. The information processing device according to claim 4, wherein in the display control processing, in a case where the line of sight is on an area for a predetermined period of time, the area being in the area of the virtual object and different from the area of the virtual object overlapping the area of the person, the transparency of the virtual object with the increased transparency is decreased.

6. The information processing device according to claim 2, wherein in the display control processing, in a case where the line of sight has moved from the area of the person to the area of the virtual object, the transparency of the virtual object with the increased transparency is decreased.

7. The information processing device according to claim 2, wherein in the display control processing, in a case where the line of sight is on an area in a real space different from the area of the person for a predetermined period of time, the transparency of the virtual object is maintained.

8. The information processing device according to claim 2, wherein in the display control processing, in a case where the line of sight is on a background image serving as a virtual space for a predetermined period of time, the transparency of the virtual object is maintained.

9. The information processing device according to claim 1, wherein in the display control processing, in a case where the person is talking, the virtual object is controlled to be displayed in a transparent state even in a case where the line of sight is not on the area of the person.

10. The information processing device according to claim 1, wherein in the display control processing, in a case where a line of sight of the person is directed to the user, the virtual object is controlled to be displayed in a transparent state even in a case where the line of sight of the user is not on the area of the person.

11. The information processing device according to claim 1, wherein in the display control processing, the transparency of the virtual object is determined based on a distance between a position of the line of sight and the person.

12. The information processing device according to claim 1, wherein in the display control processing, the transparency of the virtual object is determined based on a distance between a position of the line of sight and the virtual object.

13. The information processing device according to claim 1,
wherein the program, when executed by the processor, further causes the information processing device to execute information acquisition processing to execute acquisition processing to acquire an angle of convergence of the user, and
wherein in the display control processing, the transparency of the virtual object overlapping the area of the person included in the captured image is determined based on the angle of convergence and the line of sight.

14. The information processing device according to claim 1, wherein in the display control processing, in a case where the person is a preliminarily registered person, the virtual object is controlled to be displayed in a transparent state even in a case where the line of sight is not on the area of the person.

15. The information processing device according to claim 1,
wherein in the display control processing, a second display different from the display is further controlled, and
wherein in the display control processing, in a case where the transparency of the virtual object is changed, a display content of the second display is changed.

16. The information processing device according to claim 15, wherein in the display control processing, in a case where the virtual object is displayed in a transparent state, the second display is controlled to display eyes of the user.

17. The information processing device according to claim 16, wherein in the display control processing, in a case where the transparency of the virtual object is decreased, the second display is controlled to display a display content different from the eyes of the user.

18. A control method of an information processing device, comprising:
obtaining a captured image;
obtaining a line of sight of a user; and
controlling a display to display a combined image obtained by combining the captured image with a virtual object,
wherein the control is performed to determine transparency of the virtual object overlapping an area of a person included in the captured image based on the line of sight of the user.

19. A non-transitory computer-readable medium that stores a program, wherein the program causes a computer to execute a control method according to claim 18.

20. An information processing system comprising:
a display device;
an image obtaining device configured to obtain a captured image;
a line-of-sight obtaining device configured to obtain a line of sight of a user; and
a display control device configured to control the display device to display a combined image obtained by combining the captured image with a virtual image,
wherein the display control device performs the control to determine transparency of the virtual object overlapping an area of a person included in the captured image based on the line of sight of the user.
